(19) United States
(12) Patent Application Publication
(10) Pub. No.: US 2017/0053546 A1
(43) Pub. Date: Feb. 23, 2017

(54) TEACHING SYSTEM AND WORKING METHOD THEREOF

(71) Applicants: BOE TECHNOLOGY GROUP CO., LTD., Beijing (CN); Beijing BOE Multimedia Technology Co., Ltd., Beijing (CN)

(72) Inventors: Jianting WANG, Beijing (CN); Shuhuan YU, Beijing (CN); Junning SU, Beijing (CN); Peng CHENG, Beijing (CN); Chao ZHANG, Beijing (CN)

(21) Appl. No.: 15/159,179

(22) Filed: May 19, 2016

(30) Foreign Application Priority Data
Aug. 19, 2015 (CN) 201510512117.2

(51) Int. Cl. G09B 7/00; G09B 7/06; G09B 7/02

(52) U.S. Cl. CPC G09B 7/00; G09B 7/02; G09B 7/06

(57) ABSTRACT

The present invention discloses a teaching system and a working method thereof. The teaching system comprises a calling unit, an acquisition unit and a judgment unit, wherein the calling unit is connected with the acquisition unit, and the judgment unit is connected with the acquisition unit; the calling unit is used for calling a test question in different databases; the acquisition unit is used for acquiring a correct answer of the called test question; and the judgment unit is used for judging, according to the correct answer of the called test question, whether an answer result input by a user is correct, and displaying a judgment result. The teaching system and the working method thereof provided by the present invention can call test questions according to requirements of users, and judge answer result of the users and provide feedbacks automatically, thereby achieving interaction with the users.

### FIELD OF THE INVENTION

The present invention relates to the field of intelligent education technology, and particularly relates to a teaching system and a working method thereof.

### BACKGROUND OF THE INVENTION

An existing electronic white board system converges various technologies such as electronic technology, software technology and the like, and can achieve paperless office and intelligent teaching by using the principle of electromagnetic induction in combination with a computer and a projector.

However, the existing electronic white board system fails to interact with a user, for example, to call a test question according to requirements of the user, to judge an answer result of the user and provide feedback automatically, and the like.

### SUMMARY OF THE INVENTION

In order to solve the above problem, the present invention provides a teaching system and a working method thereof, to solve the problem that an existing electronic white board system in the prior art cannot achieve interaction with users (e.g., calling of test questions according to requirements of users, automatic judgment and feedback on answer result of the users, and the like).

For this purpose, the present invention provides a teaching system, comprising:

a calling unit, an acquisition unit and a judgment unit, the calling unit being connected with the acquisition unit, and the judgment unit being connected with the acquisition unit, wherein:

the calling unit is used for calling a test question in different databases;

the acquisition unit is used for acquiring a correct answer of the called test question; and

the judgment unit is used for judging, according to the correct answer of the called test question, whether an answer result input by a user is correct, and displaying a judgment result.

Optionally, the teaching system further comprises an input unit, a classification unit and a storage unit, the classification unit is respectively connected with the input unit and the storage unit, and the storage unit is connected with the calling unit;

the input unit is used for inputting test questions;

the classification unit is used for classifying the input test questions into a plurality of test question banks; and

the storage unit is used for respectively storing the plurality of test question banks into a plurality of different databases.

Optionally, the teaching system further comprises a prompting unit respectively connected with the judgment unit and the storage unit, and the test question banks comprise correct test question banks and wrong test question banks; and

the prompting unit is used for prompting whether to store the called test question into the database corresponding to the correct test question bank when the judgment unit judges that the answer result is correct, and prompting whether to store the called test question into the database corresponding to the wrong test question bank when the judgment unit judges that the answer result is wrong.

Optionally, the judgment unit comprises a first judgment sub-module, a second judgment sub-module, a first comparison sub-module, a second comparison sub-module, a third comparison sub-module and a fourth comparison sub-module, the first judgment sub-module is respectively connected with the first comparison sub-module and the second judgment sub-module, and the second judgment sub-module is respectively connected with the second comparison sub-module, the third comparison sub-module and the fourth comparison sub-module;

the first judgment sub-module is used for judging whether the called test question is a text description answer type test question;

the first comparison sub-module is used for comparing the answer result with the corresponding correct answer and displaying a comparison result when the called test question is not a text description answer type test question;

the second judgment sub-module is used for determining which one of a language test question, a science test question and an art test question the test question belongs to according to a subject corresponding to the test question when the called test question is the text description answer type test question;

the second comparison sub-module is used for comparing the answer result with the corresponding correct answer according to a preset first judgment rule and displaying a comparison result when the called test question is the language test question;

the third comparison sub-module is used for comparing the answer result with the corresponding correct answer according to a preset second judgment rule and displaying a comparison result when the called test question is the science test question; and

the fourth comparison sub-module is used for comparing the answer result with the corresponding correct answer according to a preset third judgment rule and displaying a comparison result when the called test question is the art test question.

Optionally, the input unit comprises a scanning module and a processing module connected with each other;

the scanning module is used for scanning a test paper; and

the processing module is used for processing the scanned test paper to form input test questions.

Optionally, the processing module comprises a recognition sub-module and a checking sub-module connected with each other;

the recognition sub-module is used for performing character recognition on the scanned test paper by an optical character recognition technology; and

the checking sub-module is used for judging whether an error quantity of the character recognition is greater than a preset value, wherein when the error quantity of the character recognition is greater than the preset value, the scanning module rescans the test paper, and when the error quantity of the character recognition is not greater than the preset value, the user is prompted to correct errors of the character recognition.

Optionally, the classification unit comprises a first classification sub-module, a second classification sub-module and a third classification sub-module, and the second classification sub-module is respectively connected with the first classification sub-module and the third classification sub-module;

the first classification sub-module is used for classifying the input test questions into a plurality of grade test question banks according to grades corresponding to the test questions;

the second classification sub-module is used for classifying the test questions in each grade test question bank into a plurality of subject test question banks according to subjects corresponding to the test questions; and

the third classification sub-module is used for classifying the test questions in each subject test question bank into a correct test question bank and a wrong test question bank according to identifications corresponding to the test questions.

The present invention also provides a working method of a teaching system, wherein the teaching system comprises a calling unit, an acquisition unit and a judgment unit, the calling unit is connected with the acquisition unit, and the judgment unit is connected with the acquisition unit; and the working method comprises:

step S1, calling, by the calling unit, a test question in different databases;

step S2, acquiring, by the acquisition unit, a correct answer of the called test question; and

step S3, judging, according to the correct answer of the called test question, whether an answer result input by a user is correct and displaying a judgment result, by the judgment unit.

Optionally, the teaching system further comprises an input unit, a classification unit and a storage unit, and the classification unit is respectively connected with the input unit and the storage unit; and

the working method further comprises:

step S4, inputting test questions by the input unit;

step S5, classifying, by the classification unit, the input test questions into a plurality of test question banks; and

step S6, storing, by the storage unit, the plurality of test question banks into a plurality of different databases, respectively.

Optionally, the teaching system further comprises a prompting unit respectively connected with the judgment unit and the storage unit, and the test question banks comprise correct test question banks and wrong test question banks; and

the working method further comprises:

prompting, by the prompting unit, whether to store the called test question into the database corresponding to the correct test question bank when the judgment unit judges the answer result is correct; and

prompting, by the prompting unit, whether to store the called test question into the database corresponding to the wrong test question bank when the judgment unit judges the answer result is wrong.

Optionally, the judgment unit comprises a first judgment sub-module, a second judgment sub-module, a first comparison sub-module, a second comparison sub-module, a third comparison sub-module and a fourth comparison sub-module, the first judgment sub-module is respectively connected with the first comparison sub-module and the second judgment sub-module, and the second judgment sub-module is respectively connected with the second comparison sub-module, the third comparison sub-module and the fourth comparison sub-module; and

step S3 comprises:

judging, by the first judgment sub-module, whether the called test question is a text description answer type test question;

comparing, by the first comparison sub-module, the answer result with the corresponding correct answer and displaying a comparison result when the called test question is not a text description answer type test question;

determining, by the second judgment sub-module, which one of a language test question, a science test question and an art test question the test question belongs to according to a subject corresponding to the test question when the called test question is the text description answer type test question;

comparing the answer result with the corresponding correct answer according to a preset first judgment rule and displaying a comparison result by the second comparison sub-module when the called test question is the language test question;

comparing the answer result with the corresponding correct answer according to a preset second judgment rule and displaying a comparison result by the third comparison sub-module when the called test question is the science test question; and

comparing the answer result with the corresponding correct answer according to a preset third judgment rule and displaying a comparison result by the fourth comparison sub-module when the called test question is the art test question.

Optionally, the input unit comprises a scanning module and a processing module connected with each other; and

step S4 comprises:

step S41, scanning a test paper by the scanning module; and

step S42, processing the scanned test paper by the processing module to form input test questions.

Optionally, the processing module comprises a recognition sub-module and a checking sub-module connected with each other; and

step S42 comprises:

performing, by the recognition sub-module, character recognition on the scanned test paper by means of an optical character recognition technology; and

judging, by the checking sub-module, whether an error quantity of the character recognition is greater than a preset value, rescanning the test paper by the scanning module when the error quantity of the character recognition is greater than the preset value, and prompting the user to correct errors of the character recognition when the error quantity of the character recognition is not greater than the preset value.

Optionally, the classification unit comprises a first classification sub-module, a second classification sub-module and a third classification sub-module, and the second classification sub-module is respectively connected with the first classification sub-module and the third classification sub-module; and

step S5 comprises:

classifying, by the first classification sub-module, the input test questions into a plurality of grade test question banks according to grades corresponding to the test questions;

classifying, by the second classification sub-module, the test questions in each grade test question bank into a plurality of subject test question banks according to subjects corresponding to the test questions; and

classifying, by the third classification sub-module, the test questions in each subject test question bank into a correct test question bank and a wrong test question bank according to identifications corresponding to the test questions.

The present invention has the beneficial effects as follows:

the teaching system and the working method thereof provided by the present invention can call test questions according to requirements of users, and judge answer results of the users and give feedbacks automatically, thereby achieving interaction with the users.

### BRIEF DESCRIPTION OF THE DRAWINGS

FIG. 1 is a schematic structural diagram of a teaching system provided by a first embodiment of the present invention;

FIG. 2 is a schematic structural diagram of another teaching system provided by the first embodiment of the present invention;

FIG. 3 is a flow chart of a working method of a teaching system provided by a second embodiment of the present invention; and

FIG. 4 is a flow chart of another working method of a teaching system provided by the second embodiment of the present invention.

### DETAILED DESCRIPTION OF THE EMBODIMENTS

To make those skilled in the art better understand the technical solution of the present invention, a teaching system and a working method thereof provided by the present invention are further described in details below in conjunction with the accompanying drawings. It should be noted that the present invention mainly describes an electronic white board system, but other types of teaching systems which can meet the requirements of the present invention are also within the protection scope of the present invention.

### First Embodiment

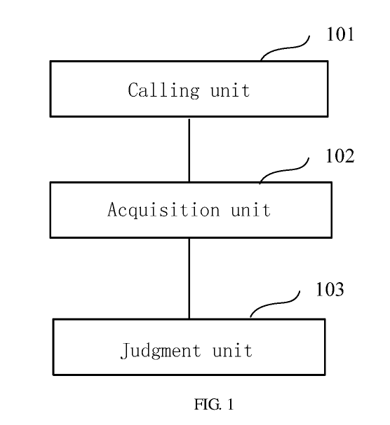

FIG. 1 is a schematic structural diagram of a teaching system provided by the first embodiment of the present invention. As shown in FIG. 1, the teaching system comprises a calling unit 101, an acquisition unit 102 and a judgment unit 103, the calling unit 101 is respectively connected with a storage unit 106 and the acquisition unit 102, and the judgment unit 103 is connected with the acquisition unit 102. The calling unit 101 is used for calling a test question in different databases, the acquisition unit 102 is used for acquiring a correct answer of the called test question, and the judgment unit 103 is used for judging, according to the correct answer of the called test question, whether an answer result input by a user is correct, and displaying a judgment result.

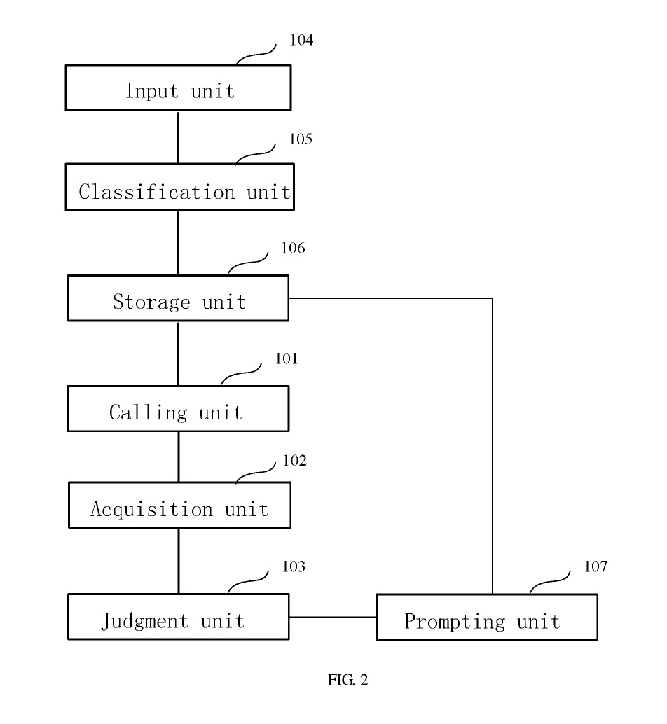

As shown in FIG. 2, optionally, the teaching system provided by the embodiment can further comprise an input unit 104, a classification unit 105 and the storage unit 106. The classification unit 105 is connected with the input unit 104 and the storage unit 106, respectively. The input unit 104 is used for inputting test questions, the classification unit 105 is used for classifying the input test questions into a plurality of test question banks, and the storage unit 106 is used for respectively storing the plurality of test question banks into a plurality of different databases.

In the embodiment, the description is given by taking the case where the teaching system is an electronic white board system as an example. Needless to say, the teaching system may be other teaching system which meets corresponding requirements.

Optionally, the input unit 104 comprises a scanning module and a processing module connected with each other. The scanning module is used for scanning test paper, and the processing module is used for processing the scanned test paper to form input test questions. In the embodiment, when the electronic white board system needs to establish the test question banks, the test paper may be scanned by an equipment such as a scanner, a camera or the like, and then the scanned test paper is processed so as to form the test questions suitable for the electronic white board system and input the test questions into the electronic white board system. Alternatively, the input unit 104 can directly input test questions in electronic version.

Preferably, the processing module comprises a recognition sub-module and a checking sub-module, and the recognition sub-module is connected with the checking sub-module. The recognition sub-module is used for performing character recognition on the scanned test paper by an optical character recognition (OCR) technology; the checking sub-module is used for determining whether an error quantity of the character recognition is greater than a preset value, and when the error quantity of the character recognition is greater than the preset value, the scanning module rescans the test paper (in this case, the recognition sub-module needs to perform character recognition on the rescanned test paper by the OCR technology, the checking sub-module needs to judge whether an error quantity of the character recognition is greater than the preset value, and this process repeats until the checking sub-module determines that the error quantity of the character recognition is not greater than the preset value); and when the error quantity of the character recognition is not greater than the preset value, a user is prompted to correct errors of the character recognition. In the embodiment, when the electronic white board system needs to establish the test question banks, the test paper may be scanned by an equipment such as a scanner, a camera or the like, then the scanned test paper is character-recognized by the OCR technology, the test paper is rescanned when the error quantity of the character recognition is greater than the preset value, and the user is prompted to correct errors of the character recognition when the error quantity of the character recognition is not greater than the preset value, thus forming the input test questions suitable for the electronic white board system. Needless to say, the scanned test paper may be character-recognized by other recognition technology.

The OCR technology in the embodiment is a process in which an image of characters on a medium (e.g. paper) is acquired by utilizing an existing OCR device, shapes of the characters are determined by detecting patterns of dark and light, and then the shapes of the characters are translated into computer texts by a character recognition software. For example, with respect to characters stamped or printed on paper, the OCR device converts the characters on the paper into a black-and-white bitmap, and the characters in the bitmap are converted into texts by the character recognition software.

The OCR technology has certain rejection rate and error rate, and thus, checking needs to be carried out. The electronic white board system may preset an upper limit value for the error quantity, i.e., the preset value. When the judgment sub-module judges that the error quantity of the character recognition is greater than the preset value, it means that there are too many recognition errors of the recognition sub-module, thus, the scanning module needs to rescan the test paper, and then the recognition sub-module performs character recognition on the rescanned test paper. When the judgment sub-module judges that the error quantity of the character recognition is not greater than the preset value, it means that there are not too many recognition errors of the recognition sub-module, thus, the character recognition errors may be manually corrected, and then the corrected test questions may enter the electronic white board system to form the test question banks.

Preferably, the classification unit 105 comprises a first classification sub-module, a second classification sub-module and a third classification sub-module, and the second classification sub-module is connected with the first classification sub-module and the third classification sub-module, respectively. The first classification sub-module is used for classifying the input test questions into a plurality of grade test question banks according to grades corresponding to the test questions, the second classification sub-module is used for classifying the test questions in each grade test question bank into a plurality of subject test question banks according to subjects corresponding to the test questions, and the third classification sub-module is used for classifying the test questions in each subject test question bank into a correct test question bank and a wrong test question bank according to identifications corresponding to the test questions. In the embodiment, the electronic white board system may establish, according to difference in grades of users, a plurality of grade test question banks different from each other, such as a first-grade test question bank, a second-grade test question bank, a third-grade test question bank, and the like. Each grade test question bank is classified into a plurality of subject test question banks, such as a mathematics test question bank, a Chinese test question bank, an English test question bank, and the like. Each subject test question bank is classified into a correct test question bank and a wrong test question bank. The correct test question banks and the wrong test question banks may be classified based on identifications at the top of the test paper.

In the embodiment, when a certain test question in the test question banks needs to be called, the calling unit 101 may call the test question according to classification rules (which have been described above) of the classification unit 105, and a user gives an answer on an electronic white board. A correct answer of the test question output on the electronic white board is acquired by the acquisition unit 102, and the judgment unit 103 judges, according to the correct answer of the test question, whether the answer result of the user is correct and displays a judgment result.

Preferably, the judgment unit 103 comprises a first judgment sub-module, a second judgment sub-module, a first comparison sub-module, a second comparison sub-module, a third comparison sub-module and a fourth comparison sub-module, the first judgment sub-module is connected with the first comparison sub-module and the second judgment sub-module, respectively, and the second judgment sub-module is connected with the second comparison sub-module, the third comparison sub-module and the fourth comparison sub-module, respectively. The first judgment sub-module is used for judging whether the called test question is a text description answer type test question, the first comparison sub-module is used for comparing the answer result input by the user with the corresponding correct answer (acquired by the acquisition unit 102) and displaying a comparison result when the called test question is not a text description answer type test question, the second judgment sub-module is used for determining which one of a language test question, a science test question and an art test question the test question belongs to according to the subject corresponding to the test question when the called test question is a text description answer type test question, the second comparison sub-module is used for comparing the answer result with the corresponding correct answer according to a preset first judgment rule and displaying a comparison result when the called test question is a language test question, the third comparison sub-module is used for comparing the answer result with the corresponding correct answer according to a preset second judgment rule and displaying a comparison result when the called test question is a science test question, and the fourth comparison sub-module is used for comparing the answer result with the corresponding correct answer according to a preset third judgment rule and displaying a comparison result when the called test question is an art test question.

In the embodiment, the test questions are classified into the text description answer type test questions and the non-text description answer type test questions according to whether the answers of the test questions require text description. The text description answer type test questions may be test questions which need to be answered by using texts, such as fill-in-the-blank questions, short answer questions, essay questions and the like; the non-text description answer type test questions may be test questions which can be answered without texts, such as choice questions, true or false questions and the like, for example, a choice question needs to be answered by using an English letter, and a true or false question needs to be answered by using a tick (✓) or a cross (X). In addition, the text description answer type test questions are classified into the language test questions, the science test questions and the art test questions according to the subjects corresponding to the test questions, the language test questions comprise test questions related to languages such as Chinese, English, Japanese, Russian, French and the like, the science test questions comprise test questions related to sciences such as mathematics, physics, chemistry, biology and the like, and the art test questions comprise test questions related to arts such as politics, history, geography and the like. When the called test question is a non-text description answer type test question (a true or false question or a choice question), the electronic white board system automatically calls the stored correct answer, compares the stored correct answer with the answer of the user, and displays whether the answer of the user is correct or not. When the called test question is a text description answer type test question, the second judgment sub-module determines which one of a language test question, a science test question and an art test question the text description answer type test question belongs to according to the subject corresponding to the test question. For a language test question related to English, Chinese or the like, the second comparison sub-module firstly extracts key words of the answer result, compares the extracted key words with the correct answer to judge whether the answer result is correct, then judges smoothness of the answer result according to grammar, and finally, displays a judgment result. For a science test question related to mathematics, physics, chemistry or the like, the third comparison sub-module firstly sets an answering rule (e.g., answering is carried out according to a first step, a second step, a third step and the like), then judges whether the answer result is correct according to the answering rule, and finally, displays a judgment result. Specifically, the third comparison sub-module needs to judge whether the answer result in each step is correct; if the answer result in each step is correct, the finally displayed judgment result is correct; and if the answer result in any step is wrong, the finally displayed judgment result is wrong. For an art test question related to politics, history or the like, the fourth comparison sub-module firstly divides the correct answer into several main categories, extracts a key sentence in each category, then compares sentence by sentence to determine whether the key sentence exists in the answer result, and judges the sentence of the answer result is correct if the key sentence exists in the answer result, or else judges the sentence of the answer result is wrong. The electronic white board system provided by the embodiment can judge whether the answer result is correct or not, so that interaction with a user can be achieved.

With reference to FIG. 2, the teaching system further comprises a prompting unit 107, the prompting unit 107 is connected with the judgment unit 103 and the storage unit 106, respectively, and the test question banks comprise the correct test question banks and the wrong test question banks. The prompting unit 107 is used for prompting whether to store the called test question into the database corresponding to the correct test question bank when the judgment unit 103 judges that the answer result is correct, and prompting whether to store the called test question into the database corresponding to the wrong test question bank when the judgment unit 103 judges that the answer result is wrong. The electronic white board system provided by the present invention can store the called test question into the correct test question bank or the wrong test question bank according to whether the answer result of the called test question is correct or not, so that targeted personalized teaching can be achieved.

The teaching system provided by the embodiment can call a test question according to requirements of a user, and judge the answer result of the user and provide feedback automatically, thereby achieving interaction with the user.

### Second Embodiment

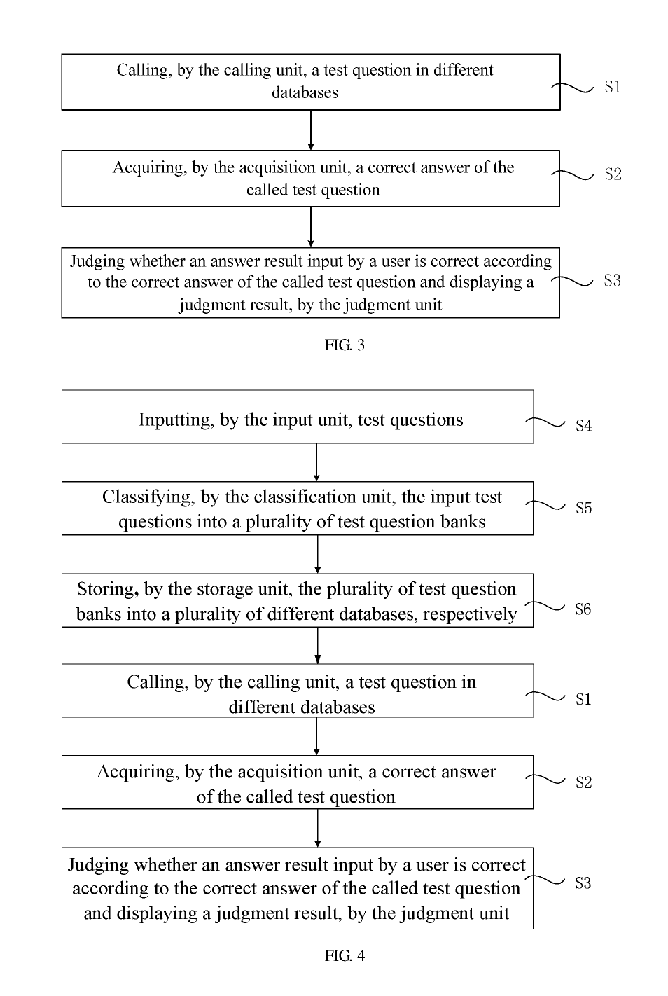

FIG. 3 is a flow chart of a working method of a teaching system provided by the second embodiment of the present invention. The teaching system comprises a calling unit, an acquisition unit and a judgment unit, the calling unit is connected with the acquisition unit, and the judgment unit is connected with the acquisition unit; and the working method comprises:

step S1, calling, by the calling unit, a test question in different databases;

step S2, acquiring, by the acquisition unit, a correct answer of the called test question; and

step S3, judging whether an answer result input by a user is correct according to the correct answer of the called test question and displaying a judgment result, by the judgment unit.

In the embodiment, the description is given by taking the case where the teaching system is an electronic white board system as an example. Needless to say, the teaching system may be other teaching system which meets corresponding requirements.

As shown in FIG. 4, optionally, the working method provided by the embodiment may further comprise:

step S4, inputting, by an input unit, test questions;

step S5, classifying, by a classification unit, the input test questions into a plurality of test question banks; and

step S6, storing, by a storage unit, the plurality of test question banks into a plurality of different databases, respectively.

Preferably, the input unit comprises a scanning module and a processing module connected with each other. The step S4 comprises: step S41, scanning a test paper by the scanning module; and S42, processing the scanned test paper by the processing module to form input test questions. In the embodiment, when the electronic white board system needs to establish test question banks, the test paper may be scanned by an equipment such as a scanner, a camera or the like, and then the scanned test paper is processed so as to form the test questions suitable for the electronic white board system and input the test questions into the electronic white board system. Alternatively, the input unit can directly input test questions in electronic version.

Preferably, the processing module comprises a recognition sub-module and a checking sub-module connected with each other. The step S42 comprises: performing, using the recognition sub-module, character recognition on the scanned test paper by an optical character recognition (OCR) technology; judging, by the checking sub-module, whether an error quantity of the character recognition is greater than a preset value; rescanning the test paper by the scanning module if the error quantity of the character recognition is greater than the preset value (in this case, the recognition sub-module needs to perform character recognition on the rescanned test paper by the OCR technology, and the checking sub-module needs to judge whether an error quantity of the character recognition is greater than the preset value, and this process repeats until the checking sub-module judges that the error quantity of the character recognition is not greater than the preset value); and prompting the user to correct error(s) of the character recognition if the error quantity of the character recognition is not greater than the preset value. In the embodiment, when the electronic white board system needs to establish the test question banks, the test paper may be scanned by an equipment such as a scanner, a camera or the like, then the scanned test paper is character-recognized by the OCR technology, the test paper is rescanned when the error quantity of the character recognition is greater than the preset value, and when the error quantity of the character recognition is not greater than the preset value, the user is prompted to correct the error(s) of the character recognition, thus forming the input test questions suitable for the electronic white board system. Needless to say, the scanned test paper may be character-recognized by other recognition technology.

The OCR technology has certain rejection rate and error rate, and thus, checking needs to be carried out. The electronic white board system may preset an upper limit value for the error quantity, i.e., the preset value. When the judgment sub-module judges that the error quantity of the character recognition is greater than the preset value, it means that there are too many recognition errors of the recognition sub-module, and thus, the scanning module needs to rescan the test paper, and then the recognition sub-module performs character recognition on the rescanned test paper. When the judgment sub-module judges that the error quantity of the character recognition is not greater than the preset value, it means that there are not too many recognition errors of the recognition sub-module, and thus, the error(s) of the character recognition may be manually corrected, and the corrected test questions may enter the electronic white board system to form the test question banks.

Preferably, the classification unit comprises a first classification sub-module, a second classification sub-module and a third classification sub-module, and the second classification sub-module is connected with the first classification sub-module and the third classification sub-module, respectively. The step S5 comprises: classifying, by the first classification sub-module, the input test questions into a plurality of grade test question banks according to grades corresponding to the test questions; classifying, by the second classification sub-module, the test questions in each grade test question bank into a plurality of subject test question banks according to subjects corresponding to the test questions; and classifying, by the third classification sub-module, the test questions in each subject test question bank into a correct test question bank and a wrong test question bank according to identifications corresponding to the test questions. In the embodiment, the electronic white board system, according to difference in grades of users, may establish a plurality of different grade test question banks, such as a first-grade test question bank, a second-grade test question bank, a third-grade test question bank, and the like. Each grade test question bank is classified into a plurality of subject test question banks such as a mathematics test question bank, a Chinese test question bank, an English test question bank, and the like. Each subject test question bank is classified into a correct test question bank and a wrong test question bank. The correct test question banks and the wrong test question banks may be classified based on identifications at the top of the test paper.

In the embodiment, when a certain test question in the test question banks needs to be called, the calling unit may call the test question according to the classification rules (which have been described above) of the classification unit, and a user gives an answer on an electronic white board. A correct answer of the test question output on the electronic white board is acquired by the acquisition unit, and the judgment unit judges, according to the correct answer of the test question, whether the answer result of the user is correct, and displays a judgment result.

Preferably, the judgment unit comprises a first judgment sub-module, a second judgment sub-module, a first comparison sub-module, a second comparison sub-module, a third comparison sub-module and a fourth comparison sub-module, the first judgment sub-module is connected with the first comparison sub-module and the second judgment sub-module, respectively, and the second judgment sub-module is connected with the second comparison sub-module, the third comparison sub-module and the fourth comparison sub-module, respectively. The step S3 comprises: judging, by the first judgment sub-module, whether the called test question is a text description answer type test question; when the called test question is a non-text description answer type test question, comparing the answer result with the corresponding correct answer (acquired by the acquisition unit) and displaying a comparison result, by the first comparison sub-module; when the called test question is a text description answer type test question, judging, by the second judgment sub-module, which one of a language test question, a science test question and an art test question the test question belongs to according to the subject corresponding to the test question; when the called test question is a language test question, comparing the answer result with the corresponding correct answer according to a preset first judgment rule and displaying a comparison result, by the second comparison sub-module; when the called test question is a science type test question, comparing the answer result with the corresponding correct answer according to a preset second judgment rule and displaying a comparison result, by the third comparison sub-module; and when the called test question is an art type test question, comparing the answer result with the corresponding correct answer according to a preset third judgment rule and displaying a comparison result, by the fourth comparison sub-module.

In the embodiment, the test questions are classified into the text description answer type test questions and the non-text description answer type test questions according to whether the answers of the test questions require text description. The text description answer type test questions may be test questions which need to be answered by using texts, such as fill-in-the-blank questions, short answer questions, essay questions, and the like; the non-text description answer type test questions may be test questions which can be answered without texts, such as choice questions, true or false questions, and the like, for example, a choice question needs to be answered by using an English letter, and a true or false question needs to be answered by using a tick (✓) or a cross (X). In addition, the text description answer type test questions are classified into the language test questions, the science test questions and the art test questions according to the subjects corresponding to the test questions, the language test questions comprise test questions related to languages such as Chinese, English, Japanese, Russian, French and the like, the science test questions comprise test questions related to sciences such as mathematics, physics, chemistry, biology and the like, and the art test questions comprise test questions related to arts such as politics, history, geography and the like. When the called test question is a non-text description answer type test question (a true or false question or a choice question), the electronic white board system automatically calls the stored correct answer, compares the stored correct answer with the answer result, and displays whether the answer is correct or not. When the called test question is a text description answer type test question, the second judgment sub-module further determines which one of a language test question, a science test question and an art test question the text description answer type test question belongs to according to the subject corresponding to the test question. For a language test question related to English, Chinese or the like, the second comparison sub-module firstly extracts key words of the answer result, compares the extracted key words with the correct answer to judge whether the answer result is correct, then judges smoothness of the answer result according to grammar, and finally, displays a judgment result. For a science test question related to mathematics, physics, chemistry or the like, the third comparison sub-module firstly sets an answering rule (e.g., answering is carried out according to a first step, a second step, a third step and the like), then judges whether the answer result is correct according to the answering rule, and finally, displays a judgment result. Specifically, the third comparison sub-module needs to judge whether the answer result in each step is correct; if the answer result in each step is correct, the finally displayed judgment result is correct; and if the answer result in any step is wrong, the finally displayed judgment result is wrong. For an art test questions related to politics, history or the like, the fourth comparison sub-module firstly divides the correct answer into several main categories, extracts a key sentence in each category, then compares sentence by sentence to determine whether the key sentence exists in the answer result, and judges that the sentence of the answer result is correct if the key sentence exists in the answer result, or else judges that the sentence of the answer result is wrong. The electronic white board system provided by the embodiment can judge whether the answer result is correct or not, so that targeted personalized teaching can be achieved.

The teaching system further comprises a prompting unit connected with the judgment unit and the storage unit, respectively, and the test question banks comprise the correct test question banks and the wrong test question banks. The working method further comprises: when the judgment unit judges that the answer of the user is correct, prompting, by the prompting unit, whether to store the called test question into the databases corresponding to the correct test question bank; and when the judgment unit judges that the answer of the user is wrong, prompting, by the prompting unit, whether to store the called test question into the databases corresponding to the wrong test question bank. The electronic white board system provided by the present invention can store the called test question into the correct test question bank or the wrong test question bank according to whether the answer result of the called test question is correct or not, so that targeted personalized teaching can be achieved.

The working method of a teaching system provided by the present invention can call a test question according to requirements of a user, and judge the answer result of the user and give a feedback automatically, thereby achieving interaction with the user.

The user of the teaching system provided by the present invention may be a student, or a teacher. The teaching system provided by the present invention can help the student to study independently, and also can help the teacher to carry out targeted teaching.

It could be understood that the above embodiments are only exemplary embodiments adopted to illustrate the principle of the present invention, but the present invention is not limited thereto. Various variations and improvements may be made by those of ordinary skill in the art without departing from the spirit and essence of the present invention, and these variations and improvements are also regarded as falling within the protection scope of the present invention.

1. A teaching system, comprising a calling unit, an acquisition unit and a judgment unit, the calling unit being connected with the acquisition unit, and the judgment unit being connected with the acquisition unit, wherein:
the calling unit is used for calling a test question in different databases;
the acquisition unit is used for acquiring a correct answer of the called test question; and
the judgment unit is used for judging, according to the correct answer of the called test question, whether an answer result input by a user is correct, and displaying a judgment result.

2. The teaching system according to claim 1, further comprising an input unit, a classification unit and a storage unit, the classification unit being respectively connected with the input unit and the storage unit, and the storage unit being connected with the calling unit, wherein
the input unit is used for inputting test questions;
the classification unit is used for classifying the input test questions into a plurality of test question banks; and
the storage unit is used for respectively storing the plurality of test question banks into a plurality of different databases.

3. The teaching system according to claim 2, further comprising a prompting unit respectively connected with the judgment unit and the storage unit, wherein the test question banks comprise correct test question banks and wrong test question banks; and
the prompting unit is used for prompting whether to store the called test question into the database corresponding to the correct test question bank when the judgment unit judges that the answer result is correct, and prompting whether to store the called test question into the database corresponding to the wrong test question bank when the judgment unit judges that the answer result is wrong.

4. The teaching system according to claim 2, wherein the judgment unit comprises a first judgment sub-module, a second judgment sub-module, a first comparison sub-module, a second comparison sub-module, a third comparison sub-module and a fourth comparison sub-module, the first judgment sub-module is respectively connected with the first comparison sub-module and the second judgment sub-module, and the second judgment sub-module is respectively connected with the second comparison sub-module, the third comparison sub-module and the fourth comparison sub-module;
the first judgment sub-module is used for judging whether the called test question is a text description answer type test question;
the first comparison sub-module is used for comparing the answer result with the corresponding correct answer and displaying a comparison result when the called test question is not a text description answer type test question;
the second judgment sub-module is used for further judging which one of a language test question, a science test question and an art test question the test question belongs to according to a subject corresponding to the test question when the called test question is the text description answer type test question;
the second comparison sub-module is used for comparing the answer result with the corresponding correct answer according to a preset first judgment rule and displaying a comparison result when the called test question is the language test question;
the third comparison sub-module is used for comparing the answer result with the corresponding correct answer according to a preset second judgment rule and displaying a comparison result when the called test question is the science test question; and
the fourth comparison sub-module is used for comparing the answer result with the corresponding correct answer according to a preset third judgment rule and displaying a comparison result when the called test question is the art test question.

5. The teaching system according to claim 2, wherein the input unit comprises a scanning module and a processing module connected to each other;
the scanning module is used for scanning a test paper; and
the processing module is used for processing the scanned test paper to form input test questions.

6. The teaching system according to claim 5, wherein the processing module comprises a recognition sub-module and a checking sub-module connected to each other;
the recognition sub-module is used for performing character recognition on the scanned test paper by an optical character recognition technology; and
the checking sub-module is used for determining whether an error quantity of the character recognition is greater than a preset value, wherein when the error quantity of the character recognition is greater than the preset value, the scanning module rescans the test paper, and when the error quantity of the character recognition is not greater than the preset value, the user is prompted to correct errors of the character recognition.

7. The teaching system according to claim 2, wherein the classification unit comprises a first classification sub-module, a second classification sub-module and a third classification sub-module, and the second classification sub-module is respectively connected with the first classification sub-module and the third classification sub-module;
the first classification sub-module is used for classifying the input test questions into a plurality of grade test question banks according to grades corresponding to the test questions;
the second classification sub-module is used for classifying the test questions in each grade test question bank into a plurality of subject test question banks according to subjects corresponding to the test questions; and
the third classification sub-module is used for classifying the test questions in each subject test question bank into a correct test question bank and a wrong test question bank according to identifications corresponding to the test questions.

8. A working method of a teaching system, wherein the teaching system comprises a calling unit, an acquisition unit and a judgment unit, the calling unit is connected with the acquisition unit, and the judgment unit is connected with the acquisition unit; and
the working method comprises:
step S1, calling, by the calling unit, a test question in different databases;
step S2, acquiring, by the acquisition unit, a correct answer of the called test question; and
step S3, judging, according to the correct answer of the called test question, whether an answer result input by a user is correct and displaying a judgment result, by the judgment unit.

9. The working method of a teaching system according to claim 8, wherein the teaching system further comprises an input unit, a classification unit and a storage unit, and the classification unit is respectively connected with the input unit and the storage unit; and
the working method further comprises:
step S4, inputting test questions by the input unit;
step S5, classifying, by the classification unit, the input test questions into a plurality of test question banks; and
step S6, storing, by the storage unit, the plurality of test question banks into a plurality of different databases, respectively.

10. The working method of a teaching system according to claim 9, wherein the teaching system further comprises a prompting unit respectively connected with the judgment unit and the storage unit, and the test question banks comprise correct test question banks and wrong test question banks; and
the working method further comprises:
prompting, by the prompting unit, whether to store the called test question into the database corresponding to the correct test question bank when the judgment unit judges that the answer result is correct; and
prompting, by the prompting unit, whether to store the called test question into the database corresponding to the wrong test question bank when the judgment unit judges that the answer result is wrong.

11. The working method of a teaching system according to claim 9, wherein the judgment unit comprises a first judgment sub-module, a second judgment sub-module, a first comparison sub-module, a second comparison sub-module, a third comparison sub-module and a fourth comparison sub-module, the first judgment sub-module is respectively connected with the first comparison sub-module and the second judgment sub-module, and the second judgment sub-module is respectively connected with the second comparison sub-module, the third comparison sub-module and the fourth comparison sub-module; and
step S3 comprises:
judging, by the first judgment sub-module, whether the called test question is a text description answer type test question;
comparing, by the first comparison sub-module, the answer result with the corresponding correct answer and displaying a comparison result when the called test question is not a text description answer type test question;
judging, by the second judgment sub-module, which one of a language test question, a science test question and an art test question the test question belongs to according to a subject corresponding to the test question when the called test question is the text description answer type test question;
comparing the answer result with the corresponding correct answer according to a preset first judgment rule and displaying a comparison result by the second comparison sub-module when the called test question is the language test question;
comparing the answer result with the corresponding correct answer according to a preset second judgment rule and displaying a comparison result by the third comparison sub-module when the called test question is the science test question; and
comparing the answer result with the corresponding correct answer according to a preset third judgment rule and displaying a comparison result by the fourth comparison sub-module when the called test question is the art test question.

12. The working method of a teaching system according to claim 9, wherein the input unit comprises a scanning module and a processing module connected to each other; and
step S4 comprises:
step S41, scanning a test paper by the scanning module; and
step S42, processing, by the processing module, the scanned test paper to form input test questions.

13. The working method of a teaching system according to claim 12, wherein the processing module comprises a recognition sub-module and a checking sub-module connected to each other; and
step S42 comprises:
performing, by the recognition sub-module, character recognition on the scanned test paper by means of an optical character recognition technology; and
judging, by the checking sub-module, whether an error quantity of the character recognition is greater than a preset value, rescanning the test paper by the scanning module when the error quantity of the character recognition is greater than the preset value, and prompting the user to correct errors of the character recognition when the error quantity of the character recognition is not greater than the preset value.

14. The working method of a teaching system according to claim 9, wherein the classification unit comprises a first classification sub-module, a second classification sub-module and a third classification sub-module, and the second classification sub-module is respectively connected with the first classification sub-module and the third classification sub-module; and
step S5 comprises:
classifying, by the first classification sub-module, the input test questions into a plurality of grade test question banks according to grades corresponding to the test questions;
classifying, by the second classification sub-module, the test questions in each grade test question bank into a plurality of subject test question banks according to subjects corresponding to the test questions; and
classifying, by the third classification sub-module, the test questions in each subject test question bank into a correct test question bank and a wrong test question bank according to identifications corresponding to the test questions.
